(19) United States
(12) Patent Application Publication
(10) Pub. No.: US 2017/0109326 A1
(43) Pub. Date: Apr. 20, 2017

(54) SYSTEM AND METHOD FOR IDENTIFYING PLAGIARISM IN ELECTRONIC DOCUMENTS

(71) Applicant: Xinjie Tan, Houston, TX (US)

(72) Inventor: Xinjie Tan, Houston, TX (US)

(21) Appl. No.: 14/884,586

(22) Filed: Oct. 15, 2015

(51) Int. Cl. G06F 17/21; G09B 7/02; G06F 17/22

(52) U.S. Cl. CPC G06F 17/218; G06F 17/2211; G06F 17/2264; G09B 7/02

(57) ABSTRACT

Embodiments of the present invention are related to systems and methods for detecting intentional or unintentional copying of text and further markup of similar text in digital documents. Further, it is an aspect of certain embodiments of the present invention to compare digital documents with published digital documents in order to identify and analyze risk associated with plagiarism.

### FIELD OF THE INVENTION

Embodiments of the present invention are related to systems and methods for detecting intentional or unintentional copying of text and further markup of similar text in digital documents. Further, it is an aspect of certain embodiments of the present invention to compare digital documents with published digital documents in order to identify and analyze risk associated with plagiarism.

### BACKGROUND

When authors write documents for any number of purposes, the documents are generally based on previous knowledge or concepts gathered from other experiences, such as reading, internet searching, citations from digital sources and other experiences. Authors frequently engage in the act of plagiarism, whether due to intentional or unintentional copying and re-expressing knowledge and concepts gathered from these experiences.

Plagiarism is defined as the use, without giving reasonable and appropriate credit to or acknowledging the author or source, of another person's original work, whether such work is made up of code, formulas, ideas, language, research, strategies, writing or other form(s).

However, the copying of large sections of textual content, such as including a few sentences, a whole paragraph or several paragraphs or more, is considered moderate to severe plagiarism. Moderate and severe plagiarism constitutes plagiarism, regardless of whether the material is cited or other appropriate identification means are utilized (e.g., quotation marks), even where the original sources are from the author's own publications.

Another form of plagiarism occurs when an author attempts to conceal intentional plagiarism, such as by changing the word sequence in a copied portion of textual content (e.g., a sentence). Many times authors use this method to intentionally avoid detection by software or other automated or manual review means.

However, it is infeasible to manually compare each sentence of an authored work to billions of digital literatures and other textual content sources. This is made even more complex when the author attempts to conceal the plagiarism, such as by changing the sequence of words in the textual content intentionally.

Therefore there is a need in the art for a system and method for detecting plagiarism, including concealed plagiarism, and providing marked up documents that assist with the ability of users to perceive and comprehend the nature, type and extent of such plagiarism, including concealed plagiarism. These and other features and advantages of the present invention will be explained and will become obvious to one skilled in the art through the summary of the invention that follows.

### SUMMARY OF THE INVENTION

Accordingly, it is an object of the present invention to provide a system and method for detecting plagiarism, including concealed plagiarism, and providing marked up documents that assist with the ability of users to perceive and comprehend the nature, type and extent of such plagiarism, including concealed plagiarism.

According to an embodiment of the present invention, a system for detecting plagiarism and providing marked up documents that assist with the ability of users to perceive and comprehend the nature, type and extent of such plagiarism comprises: a computer processor; a non-volatile computer-readable memory; and a data receiving interface, wherein the non-volatile computer-readable memory is communicatively connected to said processor and data receiving interface and is configured with computer instructions configured to: receive a text document via said data receiving interface; determine document type of said text document; process document into textual components based on said document type; retrieve one or more comparison documents, wherein said one or more comparison documents are documents the textual components will be compared against in order to identify plagiarism; analyze textual components of said text document against each of said one or more comparison documents; generate one or more reports detailing similarities between said textual components and said one or more text documents and identifying said similarities with visual indicia; and transmitting said one or more reports via said data receiving interface.

According to an embodiment of the present invention, the analyzing of textual components against each of said one or more comparison documents comprises: identifying common words in said textual components; and comparing similarities between said text components and each of said one or more comparison documents without treating common words as copy words.

According to an embodiment of the present invention, the generating of reports detailing similarities between said textual components and said one or more text documents and identifying said similarities with visual indicia comprises: visually identifying copy words sharing similarities between said textual components and said one or more comparison documents; and visually identifying common words sharing similarities between said textual components and said one or more comparison documents.

According to an embodiment of the present invention, the generating of reports detailing similarities between said textual components and said one or more comparison documents and identifying said similarities with visual indicia further comprises placing a visual indicia marker at a start point of similarities identified between said textual components and said one or more comparison documents.

According to an embodiment of the present invention, the generating of reports detailing similarities between said textual components and said one or more comparison documents and identifying said similarities with visual indicia further comprises placing a plurality of visual indicia markers, where each visual indicia marker denotes the start point of a similarity identified between said textual components and said one or more comparison documents.

According to an embodiment of the present invention, the visual indicia comprise a graphical element and a numerical element, wherein said graphical element is configured to alert a user to the presence of similarities between said textual components and said one or more comparison documents and said numerical element is configured to reference a matching summary corresponding to said similarities between said textual components and said one or more comparison documents.

According to an embodiment of the present invention, the matching summary comprises information for identifying the comparison document for which the textual components shares similarities with.

According to an embodiment of the present invention, the matching summary further comprises data associated with said similarities.

According to an embodiment of the present invention, the data comprises information identifying the amount of similarities between said textual components and said comparison document.

According to an embodiment of the present invention, the non-volatile computer-readable memory is further configured with computer instructions configured to transform said text document into an appropriate document type from an original document type.

According to an embodiment of the present invention, a method for detecting plagiarism and providing marked up documents that assist with the ability of users to perceive and comprehend the nature, type and extent of such plagiarism comprises the steps of: receiving a text document via a data receiving interface; determining document type of said text document; processing document into textual components based on said document type; retrieving one or more comparison documents, wherein said one or more comparison documents are documents the textual components will be compared against in order to identify plagiarism; analyzing textual components of said text document against each of said one or more comparison documents; generating one or more reports detailing similarities between said textual components and said one or more text documents and identifying said similarities with visual indicia; and transmitting said one or more reports via said data receiving interface.

According to an embodiment of the present invention, the analyzing of textual components against each of said one or more comparison documents comprises: identifying common words in said textual components; and comparing similarities between said text components and each of said one or more comparison documents without treating common words as copy words.

According to an embodiment of the present invention, the generating of reports detailing similarities between said textual components and said one or more text documents and identifying said similarities with visual indicia comprises: visually identifying copy words sharing similarities between said textual components and said one or more comparison documents; and visually identifying common words sharing similarities between said textual components and said one or more comparison documents.

According to an embodiment of the present invention, the method further comprises the step of transforming said text document into an appropriate document type from an original document type.

### BRIEF DESCRIPTION OF THE DRAWINGS

FIG. 1 illustrates an exemplary process flow for detecting plagiarism, including concealed plagiarism, and providing marked up documents that assist with the ability of users to perceive and comprehend the nature, type and extent of such plagiarism, including concealed plagiarism;

FIG. 2 illustrates an exemplary process flow for detecting plagiarism, including concealed plagiarism, and providing marked up documents that assist with the ability of users to perceive and comprehend the nature, type and extent of such plagiarism, including concealed plagiarism;

FIG. 3 illustrates an example of a graphical interface element with visual indicia for presenting similarities and plagiarism to users as utilized in certain embodiments of the present invention;

FIG. 4 illustrates a schematic overview of a computing device, in accordance with an embodiment of the present invention;

FIG. 5 illustrates a schematic overview of an embodiment of a system for detecting plagiarism, including concealed plagiarism, and providing marked up documents that assist with the ability of users to perceive and comprehend the nature, type and extent of such plagiarism, including concealed plagiarism;

FIG. 6 illustrates a schematic overview of an embodiment of a system for detecting plagiarism, including concealed plagiarism, and providing marked up documents that assist with the ability of users to perceive and comprehend the nature, type and extent of such plagiarism, including concealed plagiarism;

FIG. 7 is an illustration of a network diagram for a cloud based portion of the system, in accordance with an embodiment of the present invention; and

FIG. 8 is an illustration of a network diagram for a cloud based portion of the system, in accordance with an embodiment of the present invention.

### DETAILED SPECIFICATION

Embodiments of the present invention are related to systems and methods for detecting intentional or unintentional copying of text and further markup of similar text in digital documents. Further, it is an aspect of certain embodiments of the present invention to compare a first digital document with a set of one or more secondary digital documents in order to identify and analyze risk associated with plagiarism. In general the secondary digital documents may include, but are not limited to, digital publications, manuscripts, papers, assignments, theses, digital books, website content, blog content, project grants, or any combination thereof. One of ordinary skill in the art would appreciate that there are numerous types of digital documents that could be utilized with embodiments of the present invention, and embodiments of the present invention are contemplated for use with any appropriate type of digital documents.

According to an embodiment of the present invention, the system is configured to receive a first digital document from a user via a data receiving means (i.e., communications means). The data receiving means may be, for instance, any means for communicating data over one or more networks or to one or more peripheral devices attached to the system. Appropriate communications means may include, but are not limited to, wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

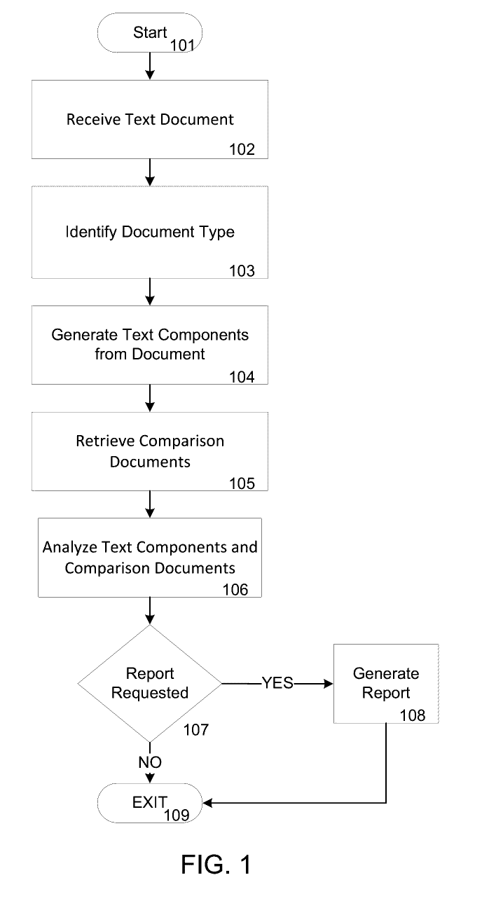

Once received by the system, the first digital document is compared to one or more secondary documents to determine the amount of similarities between the first digital document and each of the secondary documents. An exemplary process of this is shown in FIG. 1. In this FIG. 1, the process starts at step 101 with the user engaging the system for the purpose of identifying potential plagiarism in a first digital document.

At step 102, the first digital document is received at the data receiving means of the system. As noted above, receipt of the digital document can be accomplished in a variety of manners involving local (e.g., USB port, connected storage means, system memory, memory cards, portable mediums) or remote data sources (e.g., remote data stores, databases, cloud services, URLs, APIs) or any combination thereof. One of ordinary skill in the art would appreciate that there are numerous methods for providing a document to a system for use, and embodiments of the present invention are contemplated for use with any such methods.

At step 103, the system identifies the type of document received from the data receiving means. The type of document is important to the system as the system will have to ensure that it can translate the text of the document into textual components for comparison against the one or more secondary documents. Certain types of documents may need to be converted into textual components prior to processing (e.g., PDFs). In this case, the system may utilize one or more document conversion methods to ensure compatibility. For instance, the system may incorporate and use an optical character recognition means to convert documents or images into an appropriate document type for use with the system.

At step 104, the system generates text components from the first document (or the processed document as the case may be). Text components are individual pieces of the first document that may be compared against portions of text from the secondary documents. For instance, a text component could be, but is not limited to, a sentence, a paragraph, a page of text, a line of text or any combination thereof.

Once the text components are generated from the first document, or prior to or concurrent with this process, the system will retrieve one or more secondary documents (i.e., comparison documents) to compare against the first document (step 105). Retrieval of the one or more secondary documents may be accomplished in a number of manners. Retrieval could be, for instance, (i) from local sources, such as memory, data stores, databases, storage mediums, connected devices or storage means, (i) from remote sources, such as databases, cloud services, cloud storage means, application programming interfaces (APIs), or (iii) any combination thereof. One of ordinary skill in the art would appreciate that there are numerous means for retrieving comparison documents, and embodiments of the present invention are contemplated for use with any appropriate means.

According to an embodiment of the present invention, a user may dictate which secondary documents will be used in the comparison. Selection of these secondary documents can be done in a variety of manners, such the system offering a graphical user interface (GUI) wherein the user is provided the ability to select or in some cases submit secondary documents for use in the analysis. This selection or submission process can be done in numerous manners, and embodiments of the present invention are contemplated for use with any means for selecting secondary documents to compare against the first document.

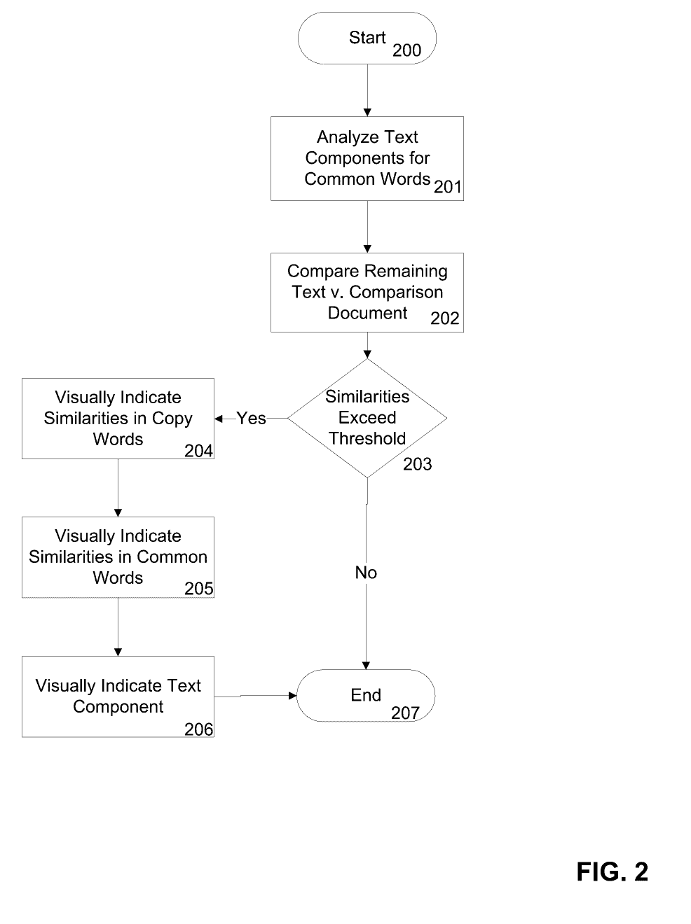

Once the system has processed the first document and has the secondary documents to be compared against the first document, the system can begin the process of analyzing the documents for similarities and potential plagiarism (step 106). A preferred embodiment of the analysis process is shown in FIG. 2. At step 200, the analysis starts.

At step 201, the system will take a text component and identify common words for removal from the similarity weighting process. Common words are words that find frequent use in all writings. For instance, common words include, but are not limited to, “a”, “the”, “you”, “he”, “she”, “it” and “I”. Since these words appear frequently, they may cause unintentional false positives of plagiarism where a text component and comparison text utilize a high ratio of common words.

Once the common words are identified, the system will compare the remaining text of the text components to the one or more comparison documents (step 202). In preferred embodiments, the system will determine the amount of words that correlate between the text components and the comparison documents. Since the system is comparing words, not ordering of those words, intentional plagiarism involving reorganization of text can be detected through use of embodiments of the present invention.

In certain embodiments, the system can also be configured to use synonymous words for words found in the text components in the analysis process. This allows for the detection of intentional plagiarism involving substituting words that meant the same thing in order to avoid detection. For instance, a plagiarist could substitute “feline” for “cat” or “canine” for “dog.” If only the words of the text components are used, then such plagiarism would potentially go undetected.

Once a text component has been compared to the comparison documents, the system will analyze the amount of similarities found between the two. At step 203, a decision is made to determine whether any similarities exceed a threshold used to indicate potential or actual plagiarism. The actual threshold can vary or be set in numerous manners. For instance, the system could allow a user to set the threshold required to trigger further analysis regarding plagiarism. In other embodiments, the system could be configured with predetermined threshold limits. One of ordinary skill in the art would appreciate that there are numerous methods for setting and changing these types of thresholds, and embodiments of the present invention are contemplated for use with any appropriate method.

If the threshold is exceeded, the system will begin the process of visually indicating the actual or potential plagiarism. At step 204, the system uses indicia to visually identify copy words. Copy words are non-common word matches between the text components and comparison documents. Visual identification may be accomplished in several ways, including, but not limited to, highlighting, underlining, setting text/font to stand out from other ordinary text (e.g., increased font size, font color, bold, italics), or any combination thereof. One of ordinary skill in the art would appreciate that there are numerous methods for making font/text stand out or otherwise highlighting such text, and embodiments of the present invention are contemplated for use with any such appropriate methods.

At step 205, the system applies indicia to visually identify common words. Even though the common words are not used in the analysis process for identifying whether similarities exceed the threshold value, once potential or actual plagiarism has been identified, the system will indicate all similarities, including common words. Application of visual indicia for common words is similar to copy words above.

At step 206, the system applies visually identifiable indicia to the text component as a whole. This is used to help identify areas in the document, as originally provided, where potential or actual plagiarism exists. Since the text components are individual subcomponents of the document as a whole, when a report is later generated, it is advantageous to highlight areas in the document that contain similarities. In a preferred embodiment, the system applies a geometric identifier, as the visual indicia, at the start point of identified similarities (e.g., triangle, square, circle). Further, the visual indicia may include a text component as well, such as a reference numeral that can be used to reference additional information about the similarities found.

In a preferred embodiment of the present invention, the color used on the visually identifiable indicia, visually identified common words and visually identified copy words will all be the same color for a text component. Separate text components in a document received from a user may use different colors from one another (e.g., a first text component of a document may use a first color for its copy words, common words and visual indicia and a second text component of a document may use a second color for its copy words, common words and visual indicia).

In other embodiments, two or more colors can be used for each of a text component's common words, copy words and visually identifiable indicia. For example, a first color could be used for the common words and copy words, while a second color could be used for the visually identifiable indicia. For instance, the color of the visually identifiable indicia could represent the amount of similarity in a given text component (e.g., red meaning above 80% similar, yellow meaning 30-79% similar, green meaning 0-29% similar). One of ordinary skill in the art would appreciate that there are numerous methods and applications of color schemes that could be utilized with embodiments of the present invention, and embodiments of the present invention are contemplated for use with any appropriate method and application of such color schemes.

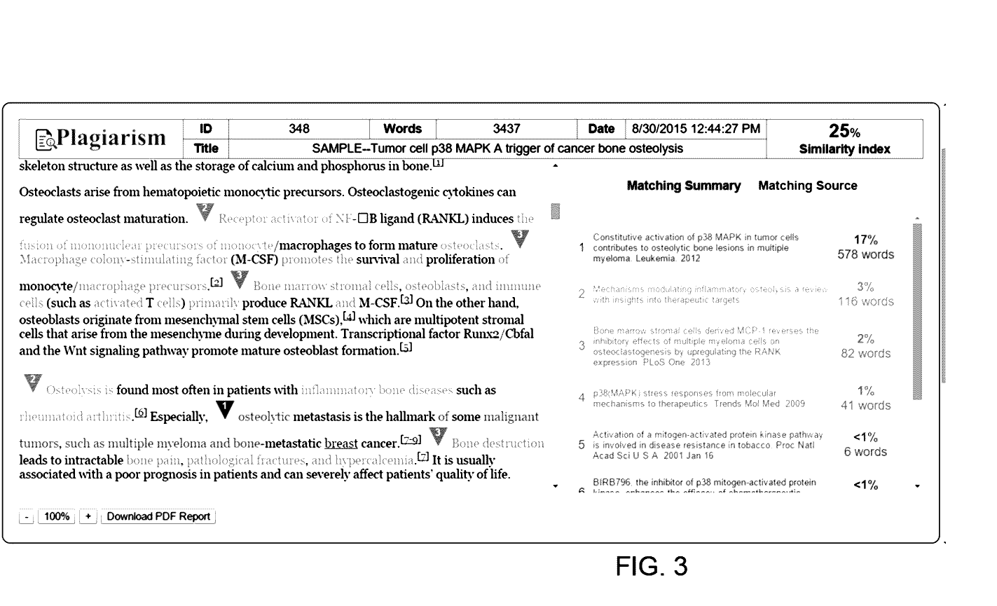

An exemplary embodiment of the use of visual indicia is shown in FIG. 3. In this embodiment, triangles are utilized as visual indicia for identifying the various text components of the first document that contain potential or actual plagiarism. Reference numbers are utilized to associate the various text components with additional information contained on a side bar of the report. For instance, the additional information could include, but is not limited to, information about the source literature/document that matched with the text component, amount of similarities, links to the source literature, publication information about the source literature, or any combination thereof. Common and copy words are shown via text of a different color from the standard document text. It should be understood that the embodiment in FIG. 3 is just one embodiment, and the invention is contemplated for use with any number and kind of visual indicia.

In a preferred embodiment of the present invention, the additional information displayed in the report could also include a window or other graphical feature showing copy words and potential substitutes for those copy words in order to help authors avoid plagiarism or plagiarizing the work of others. In certain embodiments, options for rephrasing may also be presented in the report (e.g., reorganizing sentence structure and/or replacing copy words and/or common words).

Returning to FIG. 2, once the visual indicia is applied the process terminates at step 207. Similarly, if the threshold was not triggered for a particular textual component, the process terminates at step 207.

Returning to FIG. 1, once the analysis is complete, the system determines if a report is requested (step 107). If a report is requested, the system can generate one or more reports as requested by the user (step 108). Reports can be provided in numerous types with varying content and data points. For instance, a comparison report could be provided, with the comparison using the first document as the comparison source, or the secondary document could be comparison source. Further, additional information may be included in the report, such as amount of similarities (e.g., in percentages), source document from which the text component was compared against to identify the actual or potential plagiarism, links to source document, or any combination thereof. One of ordinary skill in the art would appreciate that there are numerous types of data that could be used in such reports, and embodiments of the present invention are contemplated for use with any type of information.

According to an embodiment of the present invention, reports can be displayed visually to the user of a computer system, such as via the generation of a web page containing the content and/or the visually identifiable indicia. In other cases, reports could be generated as standalone files which could be provided to users and viewed in an application (e.g., MICROSOFT WORD, ADOBE ACROBAT).

Further, after the generation of a report, the process will terminate at step 109. Usually with the provision of the report to the user. Similarly, if no report is requested, the comparison data may be stored for later use or retrieval and the process will terminate at step 109.

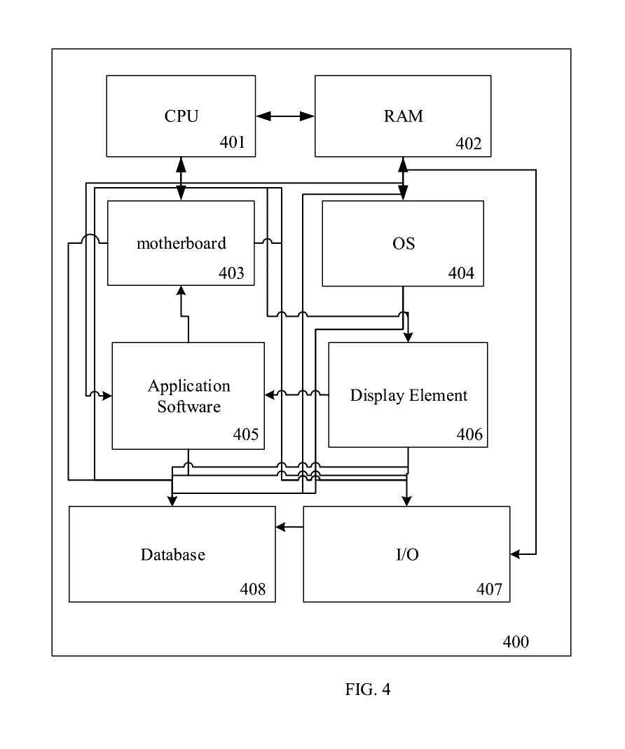

According to an embodiment of the present invention, the system and method may be configured to share and or receive data to and may be used in conjunction or through the use of one or more computing devices. As shown in FIG. 4, One of ordinary skill in the art would appreciate that a computing device 400 appropriate for use with embodiments of the present application may generally be comprised of one or more of a Central processing Unit (CPU) 401, Random Access Memory (RAM) 402, a storage medium (e.g., hard disk drive, solid state drive, flash memory, cloud storage) 403, an operating system (OS) 404, one or more application software 405, one or more display elements 406, one or more input/output devices/means 407 and one or more databases 408. Examples of computing devices usable with embodiments of the present invention include, but are not limited to, personal computers, smartphones, laptops, mobile computing devices, tablet PCs and servers. Certain computing devices configured for use with the system do not need all the components described in FIG. 4. For instance, a server may not necessarily include a display element. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

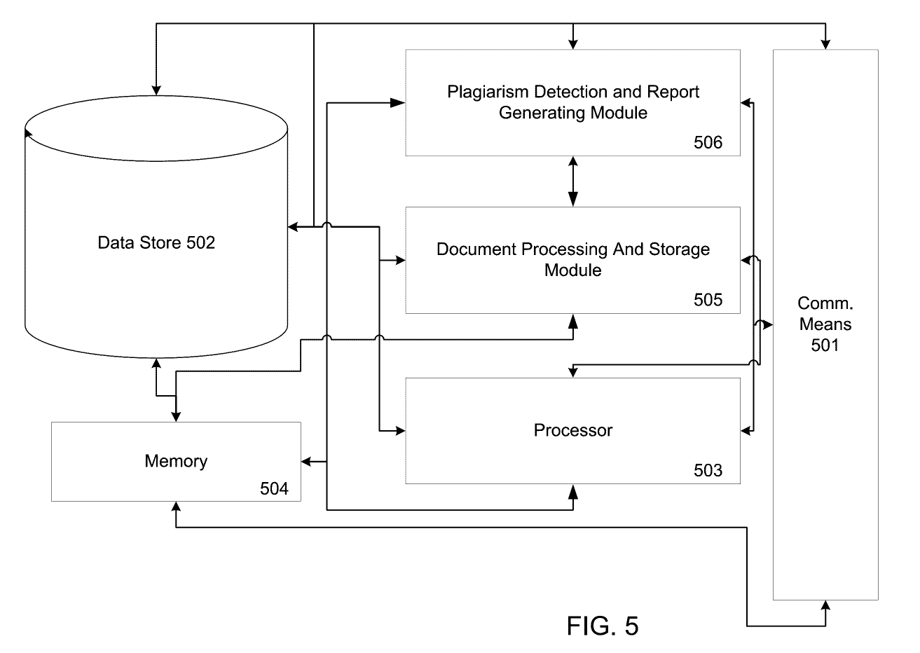

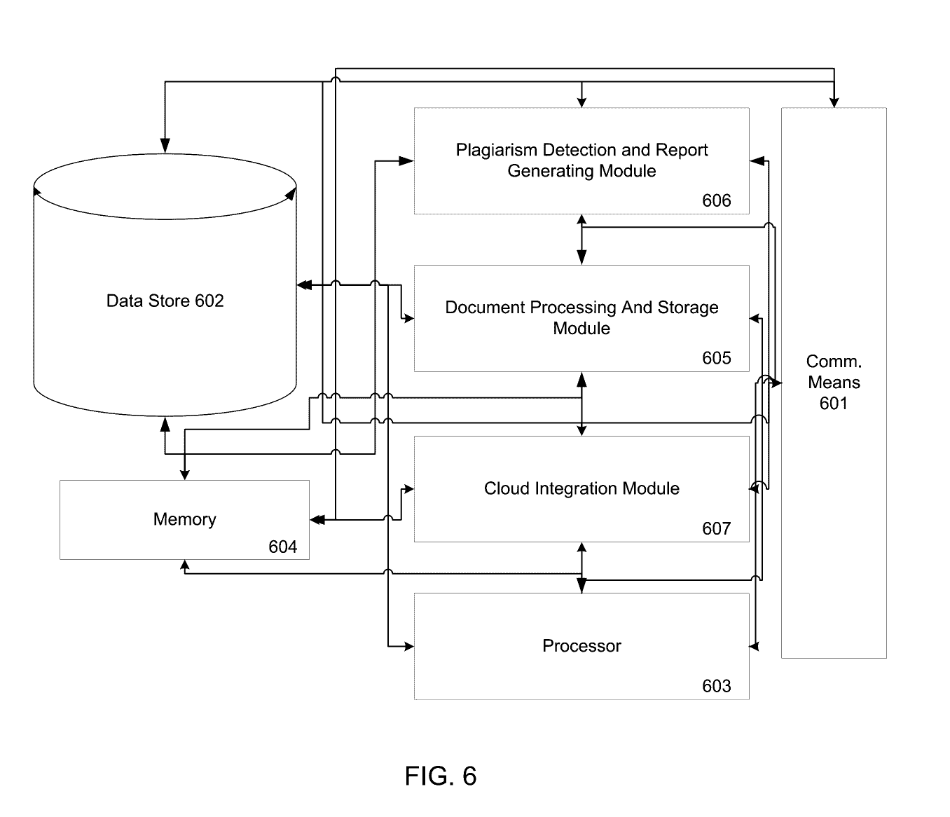

Turning to FIG. 5, according to an embodiment of the present invention, a system for detecting plagiarism and providing marked up documents that assist with the ability of users to perceive and comprehend the nature of the plagiarism is comprised of one or more communications means 501, one or more data stores 502, a processor 503, memory 504, a document processing and storage module 505 and plagiarism detection and report generating module 506. FIG. 6 shows an alternative embodiment of the present invention, comprised of one or more communications means 601, one or more data stores 602, a processor 603, memory 604, a document processing and storage module 605 and plagiarism detection and report generating module 606 and a cloud integration module 607. The various modules described herein provide functionality to the system, but the features described and functionality provided may be distributed in any number of modules, depending on various implementation strategies. One of ordinary skill in the art would appreciate that the system may be operable with any number of modules, depending on implementation, and embodiments of the present invention are contemplated for use with any such division or combination of modules as required by any particular implementation. In alternate embodiments, the system may have additional or fewer components. One of ordinary skill in the art would appreciate that the system may be operable with a number of optional components, and embodiments of the present invention are contemplated for use with any such optional component.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

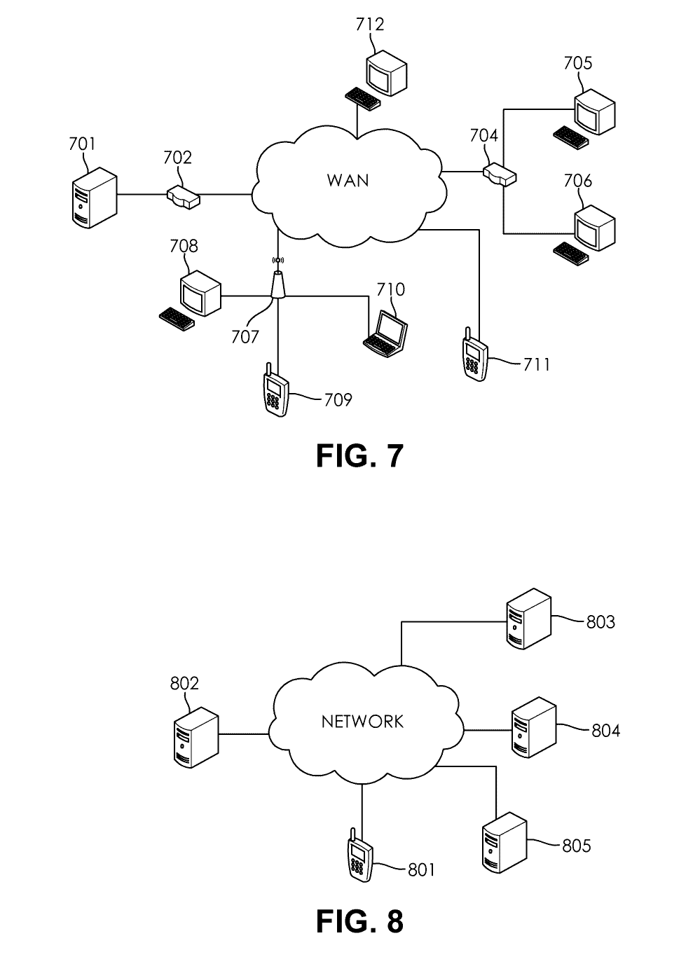

Referring to FIG. 7, a schematic overview of a cloud based system in accordance with an embodiment of the present invention is shown. The cloud based system is comprised of one or more application servers 703 for electronically storing information used by the system. Applications in the application server 203 may retrieve and manipulate information in storage devices and exchange information through a Network 701 (e.g., the Internet, a LAN, WiFi, Bluetooth, etc.). Applications in server 703 may also be used to manipulate information stored remotely and process and analyze data stored remotely across a Network 701 (e.g., the Internet, a LAN, WiFi, Bluetooth, etc.).

According to an exemplary embodiment, as shown in FIG. 7, exchange of information through the Network 701 may occur through one or more high speed connections. In some cases, high speed connections may be over-the-air (OTA), passed through networked systems, directly connected to one or more Networks 701 or directed through one or more routers 702. Router(s) 702 are completely optional and other embodiments in accordance with the present invention may or may not utilize one or more routers 702. One of ordinary skill in the art would appreciate that there are numerous ways server 703 may connect to Network 701 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 703 via Network 701 or other network in numerous ways. For instance, a component may connect to the system i) through a computing device 712 directly connected to the Network 701, ii) through a computing device 705, 706 connected to the WAN 701 through a routing device 704, iii) through a computing device 708, 709, 710 connected to a wireless access point 707 or iv) through a computing device 711 via a wireless connection (e.g., CDMA, GMS, 3G, 4G) to the Network 701. One of ordinary skill in the art would appreciate that there are numerous ways that a component may connect to server 703 via Network 701, and embodiments of the present invention are contemplated for use with any method for connecting to server 703 via Network 701. Furthermore, server 703 could be comprised of a personal computing device, such as a smartphone, acting as a host for other computing devices to connect to.

Turning now to FIG. 8, a continued schematic overview of a cloud based system in accordance with an embodiment of the present invention is shown. In FIG. 8, the cloud based system is shown as it may interact with users and other third party networks or APIs. For instance, a user of a mobile device 801 may be able to connect to application server 802. Application server 802 may be able to enhance or otherwise provide additional services to the user by requesting and receiving information from one or more of an external content provider API/website or other third party system 803, a document storage system 804, one or more additional plagiarism detection services 805 or any combination thereof. Additionally, application server 802 may be able to enhance or otherwise provide additional services to an external content provider API/website or other third party system 803, a document storage system 804, one or more additional plagiarism detection services 805 by providing information to those entities that is stored on a database that is connected to the application server 802. One of ordinary skill in the art would appreciate how accessing one or more third-party systems could augment the ability of the system described herein, and embodiments of the present invention are contemplated for use with any third-party system.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, Python, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for detecting plagiarism and providing marked up documents that assist with the ability of users to perceive and comprehend the nature, type and extent of such plagiarism, said system comprising:
a computer processor;
a non-volatile computer-readable memory; and
a data receiving interface,
wherein the non-volatile computer-readable memory is communicatively connected to said processor and data receiving interface and is configured with computer instructions configured to:
receive a text document via said data receiving interface;
determine document type of said text document;
process document into textual components based on said document type;
retrieve one or more comparison documents, wherein said one or more comparison documents are documents the textual components will be compared against in order to identify plagiarism;
analyze textual components of said text document against each of said one or more comparison documents;
generate one or more reports detailing similarities between said textual components and said one or more text documents and identifying said similarities with visual indicia; and
transmitting said one or more reports via said data receiving interface.

2. The system of claim 1, wherein the analyzing of textual components against each of said one or more comparison documents comprises:
identifying common words in said textual components; and
comparing similarities between said text components and each of said one or more comparison documents without treating common words as copy words.

3. The system of claim 2, wherein the generating of reports detailing similarities between said textual components and said one or more text documents and identifying said similarities with visual indicia comprises:
visually identifying copy words sharing similarities between said textual components and said one or more comparison documents; and
visually identifying common words sharing similarities between said textual components and said one or more comparison documents.

4. The system of claim 3, wherein the generating of reports detailing similarities between said textual components and said one or more comparison documents and identifying said similarities with visual indicia further comprises placing a visual indicia marker at a start point of similarities identified between said textual components and said one or more comparison documents.

5. The system of claim of claim 3, wherein the generating of reports detailing similarities between said textual components and said one or more comparison documents and identifying said similarities with visual indicia further comprises placing a plurality of visual indicia markers, where each visual indicia marker denotes the start point of a similarity identified between said textual components and said one or more comparison documents.

6. The system of claim 1, wherein the visual indicia comprise a graphical element and a numerical element, wherein said graphical element is configured to alert a user to the presence of similarities between said textual components and said one or more comparison documents and said numerical element is configured to reference a matching summary corresponding to said similarities between said textual components and said one or more comparison documents.

7. The system of claim 6, wherein said matching summary comprises information for identifying the comparison document for which the textual components shares similarities with.

8. The system of claim 7, wherein said matching summary further comprises data associated with said similarities.

9. The system of claim 8, wherein said data comprises information identifying the amount of similarities between said textual components and said comparison document.

10. The system of claim 1, wherein the non-volatile computer-readable memory is further configured with computer instructions configured to transform said text document into an appropriate document type from an original document type.

11. A method for detecting plagiarism and providing marked up documents that assist with the ability of users to perceive and comprehend the nature, type and extent of such plagiarism, said method comprising the steps of:
receiving a text document via a data receiving interface;
determining document type of said text document;
processing document into textual components based on said document type;
retrieving one or more comparison documents, wherein said one or more comparison documents are documents the textual components will be compared against in order to identify plagiarism;
analyzing textual components of said text document against each of said one or more comparison documents;
generating one or more reports detailing similarities between said textual components and said one or more text documents and identifying said similarities with visual indicia; and
transmitting said one or more reports via said data receiving interface.

12. The method of claim 11, wherein the analyzing of textual components against each of said one or more comparison documents comprises:
identifying common words in said textual components; and
comparing similarities between said text components and each of said one or more comparison documents without treating common words as copy words.

13. The method of claim 12, wherein the generating of reports detailing similarities between said textual components and said one or more text documents and identifying said similarities with visual indicia comprises:
visually identifying copy words sharing similarities between said textual components and said one or more comparison documents; and
visually identifying common words sharing similarities between said textual components and said one or more comparison documents.

14. The method of claim 13, wherein the generating of reports detailing similarities between said textual components and said one or more comparison documents and identifying said similarities with visual indicia further comprises placing a visual indicia marker at a start point of similarities identified between said textual components and said one or more comparison documents.

15. The method of claim of claim 13, wherein the generating of reports detailing similarities between said textual components and said one or more comparison documents and identifying said similarities with visual indicia further comprises placing a plurality of visual indicia markers, where each visual indicia marker denotes the start point of a similarity identified between said textual components and said one or more comparison documents.

16. The method of claim 11, wherein the visual indicia comprise a graphical element and a numerical element, wherein said graphical element is configured to alert a user to the presence of similarities between said textual components and said one or more comparison documents and said numerical element is configured to reference a matching summary corresponding to said similarities between said textual components and said one or more comparison documents.

17. The method of claim 16, wherein said matching summary comprises information for identifying the comparison document for which the textual components shares similarities with.

18. The method of claim 17, wherein said matching summary further comprises data associated with said similarities.

19. The method of claim 18, wherein said data comprises information identifying the amount of similarities between said textual components and said comparison document.

20. The method of claim 1, further comprising the step of transforming said text document into an appropriate document type from an original document type.
